(19) United States
(12) Patent Application Publication
(10) Pub. No.: US 2023/0253133 A1
(43) Pub. Date: Aug. 10, 2023

(54) MULTI-LAYER FOAMED ELECTRIC CABLE

(71) Applicant: Kromberg & Schubert GmbH Cable & Wire, Rhede (DE)

(72) Inventors: Martin GREINER, Hemmingen (DE); Anne BREMER, Rhede (DE)

(21) Appl. No.: 18/104,706

(22) Filed: Feb. 1, 2023

(30) Foreign Application Priority Data
Feb. 8, 2022 (DE) 10 2022 102 884.4

(51) Int. Cl. H01B 7/18; H01B 7/02; H01B 13/22

(52) U.S. Cl. CPC H01B 7/18; H01B 7/02; H01B 13/22

(57) ABSTRACT

The invention relates to an electric cable (10) comprising a plurality of electric conductors (1) each having an insulation (2) and a common sheath (3) consisting of a plastic material, characterized in that the sheath (3) is applied directly on and around the insulation (2) of the conductors (1) without an intermediate layer and the sheath (3) is selected from the group of plastic materials which are both thermoplastic and elastic plastics at the same time and preferably have a polypropylene matrix or polyethylene matrix and, furthermore, a thin hard cover layer (4) made of a non-foamed material is formed around the sheath (3).

### BACKGROUND

The invention relates to a multi-layer foamed electric cable with a specific sheath structure, and to a method for manufacturing such a cable having such a sheath structure. In this respect, the invention relates to a sheathed electric cable comprising at least one electric conductor with an insulation and a sheath structure consisting of a plastic.

Electric cables with different cable structures are known in the prior art. However, current applications and uses require electric conductor arrangements with very specific properties. The use of certain materials to achieve a certain desired advantage is usually accompanied at the same time by a disadvantage, sometimes simply by the problem that a selected plastic is expensive to purchase and to process.

A cable that has been known for a long time from the prior art is described in DE 30 05 615 A1, which relates to a flexible electric cable with a flexible base cable made of a foamed material with a large pore volume, such as based on PUR, which is encased in the form of a spiral and a coaxial PUR plastic sheath is applied on the outside.

Another known electric cable is described in DE 202 15 523 U1. This cable can be used in particular for antilock braking systems and sensors for speed measuring systems in motor vehicles and has proven itself in practice. The cable has a sheath made of polyurethane. In particular, the sheath is made of PP, i.e. polyether polyurethane, with a specific Shore hardness. This hardness is advantageously in the range of 75 to 95 Shore A. For the selection of the insulation of the conductor, for which an ethylene-vinyl acetate copolymer (EVA) is mentioned as being known in DE 202 15 523 U1, the dielectric parameters, in particular the relative dielectric constant, play an essential role in practice because these parameters have a decisive influence on the insulation capacity of the cable.

In addition to the electrical parameters, other parameters also play a role in practice, depending on the application. In general, good recyclability is desired. Moreover, dimensional stability is also important.

In order to achieve improved recyclability while maintaining high thermal stability, the mentioned utility model also provides that the insulation of the conductor itself is made of polyurethane, the latter having a hardness in the range of 55 to 64 Shore D. This polyurethane material is in particular a thermoplastic material that can be remelted and therefore easily recycled.

The disadvantage here is already the more expensive production process. With regard to the technical requirements placed on such cables, DE 202 15 523 U1 refers to Bosch regulation VS 18296-NKA (October 2001) and, in addition to recyclability, refers in particular to the technical parameters of heat deflection temperature and flexural fatigue strength in accordance with VDE 0472-603/J. Other properties, in particular mechanical properties, which are important for the use of cables of the type mentioned above include the torsional behavior in addition to the mass of the cable. For the processability of the cables, the requirement that the cable can be stripped easily, if necessary also over larger cable sections, also plays an important role.

In the prior art, solutions have been proposed for this purpose in which the sheath is made up of multiple layers of foamed and non-foamed materials, in particular of at least one non-foamed layer of PP. To achieve certain mechanical properties, reference is made in the prior art to the fact that the cover layer is to be formed as a non-foamed PP layer to improve the stripping behavior. However, it has been shown to be disadvantageous that a porous cover layer made of a non-foamed PP entails various other disadvantages in addition to porosity, and also that an adhesive bond must be achieved between the non-foamed material and a foamed intermediate layer.

### SUMMARY

An aspect of example embodiments of the present invention is therefore to create an electric cable of the type mentioned above, but which has improved quality with regard to the above-mentioned mechanical and processing properties and, in particular, can be produced in a simple and cost effective manner and has high mechanical stability towards the outside without the flexibility of the cable suffering.

These aspects are achieved by the combination of features according to claim 1.

Other advantageous further refinements of the invention are indicated in the subclaims or are illustrated in more detail below together with the description of the illustrative embodiment of the invention with reference to the FIGURE.

### BRIEF DESCRIPTION OF DRAWINGS

FIG. 1 shows an electric cable according an example embodiment of the invention.

### DETAILED DESCRIPTION OF ILLUSTRATIVE EMBODIMENTS

According to example embodiments of the invention, a specific cable structure with materials that bring particular advantages in the proposed combination is used for this purpose. A first idea is to omit the actual inner sheath around the insulations of the several cables of the electric cable assembly and to directly apply a sheath of a foamed material around the insulations in this manner. This saves, among other things, a manufacturing step and makes it possible to avoid the problem of bonding between layers of foamed and non-foamed materials.

According to example embodiments of the invention, it has been shown that a combination of certain thermoplastic polymers with foamed as well as non-foamed insulation is possible, wherein a good adhesive bond can be achieved while the mechanical and other properties remain easily manageable.

Thus, according to example embodiments of the invention, a foamed sheath material is selected from a group of plastics which are both thermoplastics and elastomers at the same time, since they combine the cost-effective processability of thermoplastics with the elastic properties of elastomers. Thermoplastic vulcanizates are suitable for this purpose.

It is particularly advantageous to use a thermoplastic polymer with a polypropylene matrix for this purpose.

Furthermore, it is advantageous if EPDM particles are embedded in the polypropylene matrix, i.e. ethylene-propylene-diene rubber particles.

Such materials can also be applied using the overmolding extrusion process to form a strong bond with engineering thermoplastics, so that thermoplastics as foamed variants can also be used as insulation material for the cables. Adhesives, binders and physical or mechanical connections that previously had to be used for such composite parts can thus be saved. Another advantage turned out to be that the method reduces the number of process steps and thus can reduce the cycle time of component production as well as overall system costs.

The elastomeric foamed sheath material used in accordance with example embodiments can be bonded particularly firmly to plastics such as polycarbonate (PC), acrylonitrile butadiene styrene (ABS), acrylonitrile styrene acrylate (ASA), polymethyl methacrylate (PMMA) and polyethylene terephthalate (PET). As a result, these hard thermoplastics and the aforementioned soft TPE sheath material are particularly well compatible. However, other material combinations can also be achieved in this manner.

In a particularly advantageous embodiment of the invention, an electric cable is provided, comprising a plurality of electric conductors each having an insulation and a common sheath consisting of a plastic, wherein the common sheath is applied directly to and around the insulation of the conductors without an intermediate layer, and the sheath is selected from the group of plastics which are both thermoplastic and elastic plastics at the same time and can have a polypropylene matrix or polyethylene matrix and, furthermore, a thin hard cover layer of a non-foamed material is formed around the sheath.

Due to the structure of a foamed layer of the mentioned material, an example embodiment of the invention advantageously effects that the specific mass of the cable is reduced, stripping over longer and oversized cable lengths is made easier, and the torsional behavior and, due to a damping effect of the foamed layer, the mechanical pressure resistance and the flexural fatigue strength are improved.

It is further advantageous if the material of the hard cover layer consists of a thermoplastic PUR. In this manner, a concept is achieved that combines in its property profile dynamic load-bearing capacity, high flexibility over a wide temperature range, high wear resistance and buckling and tear strength with good resistance to the effects of oil, grease and solvents, the weather, ozone and UV radiation, and hydrolytically active substances. Furthermore, such cables can be easily subjected to recycling.

It is also advantageous that according to an example embodiment of the invention, the material of the insulation can also consist of a foamed plastic.

In a likewise example embodiment of the invention, it is provided that no intermediate layer is arranged between the hard cover layer and the sheath and, in particular, there is also no intermediate layer with the function of promoting adhesion or establishing the mechanical connection to the sheath.

It is advantageous if the sheath is attached coaxially such as with a round cross-sectional contour around the conductors. It is also advantageous if the thin cover layer 4 is attached coaxially such as with a round cross-sectional contour around the sheath. However, other shapes, in particular non-round shapes, are also conceivable and possible.

In addition to the cable as such, a further aspect of the present invention relates also to the method for producing an electric cable as described, comprising the following steps:
(a) providing a plurality of conductors each having a foamed or non-foamed insulation in a cable bundle;
b) applying a sheath without an intermediate layer on and around the insulation of the conductors, which is made of a plastic material selected from the group of plastics which are both thermoplastic and elastic plastics at the same time and can have a polypropylene matrix or polyethylene matrix; and
(c) applying a thin hard cover layer without an intermediate layer around the sheath, namely made of a non-foamed plastic material, in particular a thermoplastic polyurethane.

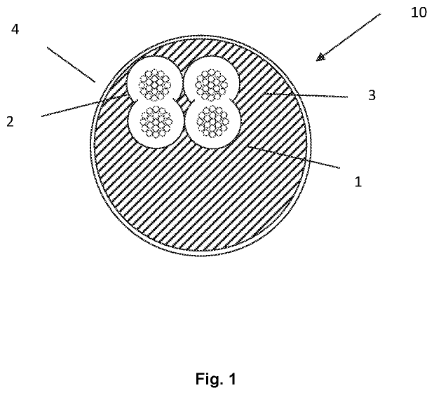

In the following, example embodiments of the invention are explained in more detail with reference to FIG. 1, which merely shows an illustrative embodiment of the invention. Other forms and structure variants are conceivable and possible while retaining the concept of the invention.

As can be seen from FIG. 1, an electric cable 10 sheathed according to the invention comprises a plurality of electric conductors 1, each of which is provided with insulation 2. In the exemplary embodiment shown, four electric conductors 1 are shown. Around these four conductors 1 and, more specifically, around their insulation 2, a common sheath 3 is provided which rests against the outer contour of the insulations 2 without an intermediate layer.

The common sheath 3 consists of a specific plastic, namely a thermoplastic vulcanizate. In the exemplary embodiment shown, the latter is formed as a thermoplastic polymer with a polypropylene matrix. EPDM particles are embedded in the polypropylene matrix, so that a thermoplastic vulcanizate with ethylene-propylene-diene rubber particles is provided.

The insulation 2 is made of a soft non-foamed material. The insulation 2 of the conductor 1 can be made of polyurethane or of a material used for such insulations, e.g. a thermoplastic elastomer (TPE), in particular styrene-containing TPE, a polyolefin, such as polypropylene (PP), an ethylene-vinyl acetate copolymer (EVA) or a fluoropolymer, such as FEP (tetrafluoroethylene-hexafluoropropylene copolymer). Other foamed or non-foamed plastics are also conceivable.

Furthermore, it can be seen that a thin hard cover layer 4 made of a non-foamed TPU is directly applied around the sheath 3.

There is no intermediate layer between the TPU skin cover layer 4 and the sheath 3.

The conductor 1 can be made of an electrically conductive material in the form of strands or in the form of a wire. A wire used for the conductor 1 can also be formed here from a plurality of individual wires 1a and thus be designed as a stranded conductor.

The invention is not limited in terms of the example embodiments described above. Rather, a number of variants is conceivable which also make use of the described solution in fundamentally different embodiments.

1. An electric cable (10) comprising a plurality of electric conductors (1) each having an insulation (2) and a common sheath (3) consisting of a plastic material, characterized in that the sheath (3) is applied directly on and around the insulation (2) of the conductors (1) without an intermediate layer and the sheath (3) is selected from the group of plastic materials which are both thermoplastic and elastic plastics at the same time and preferably have a polypropylene matrix or polyethylene matrix and, furthermore, a thin hard cover layer (4) made of a non-foamed material is formed around the sheath (3).

2. The electric cable (10) according to claim 1, characterized in that the group of plastics is or comprises thermoplastic vulcanizates.

3. The electric cable (10) according to claim 1, characterized in that the sheath material of the sheath (3) is a thermoplastic polymer with a polypropylene matrix (PP matrix).

4. The electric cable (10) according to claim 1, characterized in that the sheath material of the sheath (3) is a thermoplastic polymer with a polypropylene matrix (PP matrix), wherein EPDM particles are embedded in the polypropylene matrix.

5. The electric cable (10) according to claim 1, characterized in that the material of the hard cover layer (4) consists of a thermoplastic PUR.

6. The electric cable (10) according to claim 1, characterized in that the material of the insulation (2) consists of a foamed plastic.

7. The electric cable (10) according to claim 1, characterized in that no intermediate layer is arranged between the hard cover layer (4) and the sheath (3) and, in particular, there is also no intermediate layer with the function of promoting adhesion or establishing the mechanical connection to the sheath (3).

8. The electric cable (10) according to claim 1, characterized in that the sheath (3) is attached coaxially and preferably with a round cross-sectional contour around the conductors (1).

9. The electric cable (10) according to claim 8, characterized in that the sheath (3) is attached coaxially and preferably with a round cross-sectional contour around the sheath (3).

10. A method for producing an electric cable according claim 1, comprising the following steps:
a) providing a plurality of conductors (1) each having a foamed or non-foamed insulation (2) in a cable bundle;
b) applying a sheath (3) without an intermediate layer on and around the insulation (2) of the conductors (2), which is made of a plastic material selected from the group of plastics which are both thermoplastic and elastic plastics at the same time and preferably have a polypropylene matrix or polyethylene matrix; and
c) applying a thin hard cover layer (4) without an intermediate layer around the sheath (3), namely made of a non-foamed plastic material, in particular a thermoplastic polyurethane.
